(19) United States
(12) Patent Application Publication
(10) Pub. No.: US 2005/0286858 A1
(43) Pub. Date: Dec. 29, 2005

(54) Cradle for a multimedia player

(76) Inventor: Henri Crohas, Verrieres-Le-Buisson (FR)

Correspondence Address: YOUNG & THOMPSON, 745 SOUTH 23RD STREET, 2ND FLOOR, ARLINGTON, VA, 22202, US

(21) Appl. No.: 10/928,200

(22) Filed: Aug. 30, 2004

(30) Foreign Application Priority Data
Jun. 29, 2004 (FR) 04 07172

(51) Int. Cl. H04N 5/76; H04N 5/781

(52) U.S. Cl. 386/46; 386/125

(57) ABSTRACT

A cradle for a portable multimedia player includes at least: an audio input and a video input for receiving analogue audio and video signals, an audio output and a video output for transmitting analogue audio and video signals to an external device, and connection elements for transmitting signals originating from the cradle's inputs to the multimedia player for recording, and for transmitting signals originating from the multimedia player to the cradle's outputs.

The present invention relates to a cradle for receiving a portable multimedia player provided with digital storage means and audio and video distribution means.

Cradles for portable telephones or digital organizers are known. These cradles are intended to recharge these devices and/or connect them to a microcomputer via digital connections of the USB type for example.

An objective of the present invention is a new cradle intended for portable multimedia digital players, in particular those having numerous inputs and outputs. An objective of the invention is also to facilitate the connection between the cradle and a digital player, to provide a fixed and convenient support, and to facilitate the use of the player by the addition of connections and appropriate functions.

At least one of the aforementioned objectives is achieved with a cradle for a portable multimedia player, this player being provided with analogue-digital conversion means, recording means for recording digital signals in digital storage means and audio and video distribution means. The multimedia player is of autonomous and portable “handheld” type. The recording means can comprise a microprocessor linked to a dedicated operating system. The cradle comprises at least
an audio input and a video input for receiving analogue audio and video signals,
an audio output and a video output for transmitting analogue audio and video signals to an external device, and
connection means, on the one hand for transmitting signals originating from the cradle's inputs to the multimedia player for recording, and on the other hand for transmitting signals originating from the multimedia player to the cradle's outputs.

The analogue audio and video signals can be of the baseband, composite, S-video, or other type, and pass through corresponding connectors.

The connection means can advantageously comprise a single cable comprising a bundle of conducting wires for the transmission of signals to and from the multimedia player, the free end of the cable comprising a connector provided with several plugs to engage with corresponding plugs of the multimedia player. As a non-limiting example, all of the connector's plugs have a reduced overall dimension of approximately 3 cm² or less (front view).

With the cradle according to the invention, the multimedia player can easily be connected to analogue audio and/or video distribution devices such as a television (TV) an audio amplifier, an audio system, a video cassette recorder (VCR), a cable or satellite set top box etc. With a single cable, the connection is limited to a single connection operation. In contrast to the prior art, the connection of an audio/video multimedia player with for example a television and a satellite receiver for example required numerous connections. With the cradle according to the invention, the connections between the cradle can be carried out once for all. And when the multimedia player is to be used, it is sufficient to place it on the cradle and connect the single cable, gaining time and great efficiency since the risk of making a wrong connection is zero.

Moreover, the connection means can comprise wired links capable of directly transmitting the signals from the audio and video inputs to the multimedia player. The signals only pass via the cradle which then comprises no intelligence for modifying them.

Moreover, the cradle also comprises a power input capable of receiving the power from the mains via a power cable, to supply the cradle and to supply the multimedia player via the connection means.

Advantageously, the cradle can moreover comprise an infrared input constituted by an infrared receiver capable of receiving infrared control signals originating from a multimedia player remote control.

In particular, the cradle moreover comprises an analogue-digital converter for converting the control signals originating from the infrared receiver to digital control signals transmitted to the multimedia player via the connection means. The multimedia player receives and processes, for its own operation, the control signals sent by the remote control.

Advantageously, the cradle also comprises a digital-analogue converter for converting control signals originating from the multimedia player via the connection means to analogue control signals transmitted to an external device. In order to do this, the cradle comprises an electric output called an infrared output receiving the analogue control signals from the digital-analogue converter. An electric cable, connected to the infrared output, makes it possible to convey the analogue control signals, this cable comprising at its end an infrared chip for electric-infrared conversion fixed close to, preferably facing, infrared receiving means of the external device. More precisely, the infrared signal originating from the multimedia player can be capable of controlling a tuner of the external device. Generally, the infrared output can be used in order to control any other external device. It is also possible to control an external device connected to the output of the cradle, but it is also possible to control an external device used as an audio/video source and which is connected to the input of the cradle.

The present invention is in particular remarkable due to the fact that the user can use the multimedia player remote control in order to control several functions of the external device. For example, it is possible to adjust the quality of the image and the quality of the sound or other quality. A single remote control is then used. For the user everything is clear. In fact, the multimedia player includes a conversion table between the infrared codes to control the functions of the external device and its own infrared codes. Thus, certain control signals are received, interpreted then converted to control signals for the external device.

According to an advantageous characteristic of the invention, the cradle moreover comprises a receptacle for receiving the multimedia player. This receptacle is designed in swivelling fashion relative to the rest of the cradle constituted by a base carrying the inputs and outputs of the cradle. This receptacle comprises a housing in which the multimedia player is partially housed in the “upright” position.

According to the invention, when the cradle is placed on a horizontal plane, the swivelling axis of the receptacle is slightly inclined, for example at an angle of 30°, relative to the vertical, in such a manner that the receptacle has a first position where the multimedia player is placed vertical, and a second position after swivelling (of the receptacle) through 1800 where the multimedia player is inclined relative to the vertical. In this fashion, the user can adjust the inclination of the display screen present on the multimedia player.

With such a rotating receptacle, the information displayed on the screen of the multimedia player is made visible whatever the position of the user.

The cradle can have dimensions such that it can be “handheld”. It is therefore portable.

Other advantages and characteristics of the invention will become apparent on examination of the detailed description of an embodiment which is not at all limiting, and of the attached drawings in which:

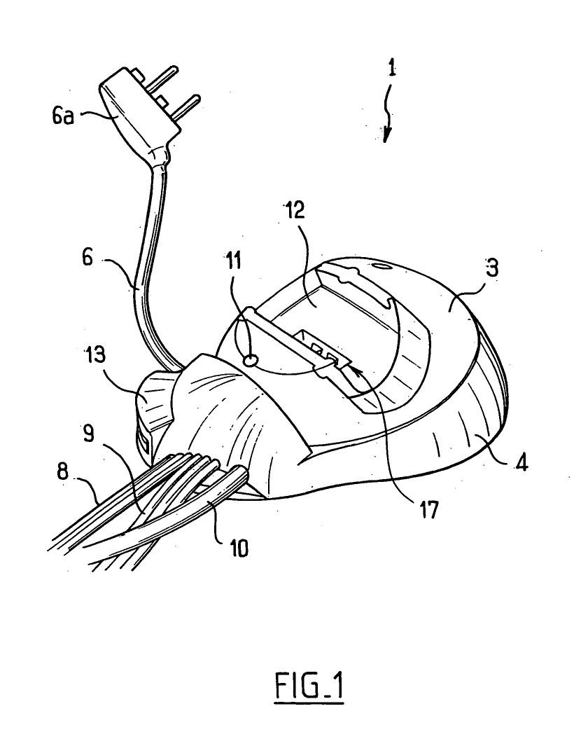

FIG. 1 is a view of the cradle only according to the invention,

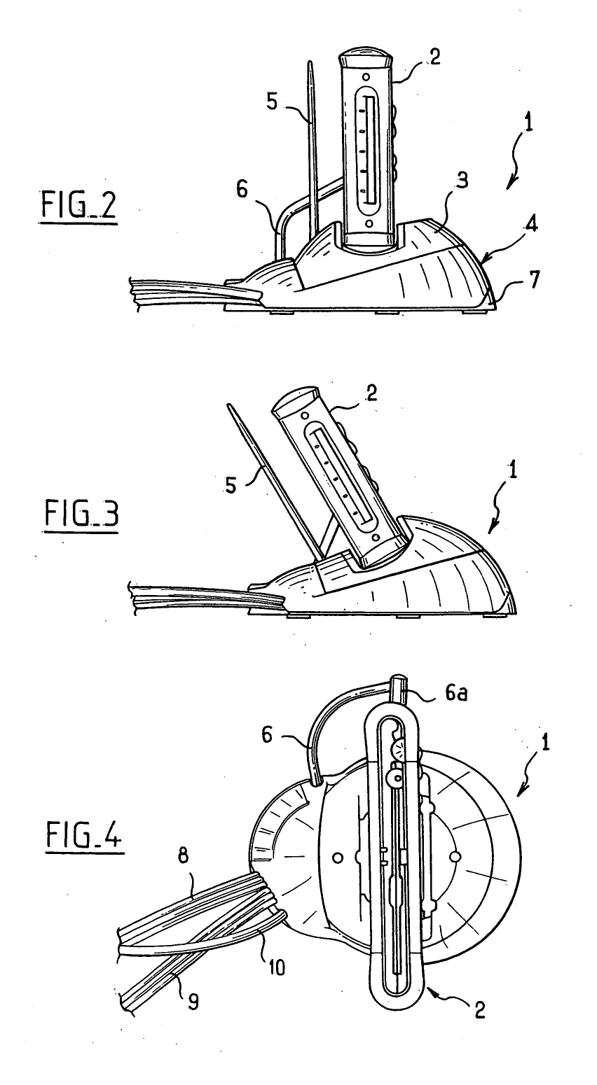

FIG. 2 is a side view of the cradle with the player in upright position according to the invention,

FIG. 3 is a side view of the cradle with the player in inclined position according to the invention,

FIG. 4 is a top view of the cradle with the player in upright position according to the invention,

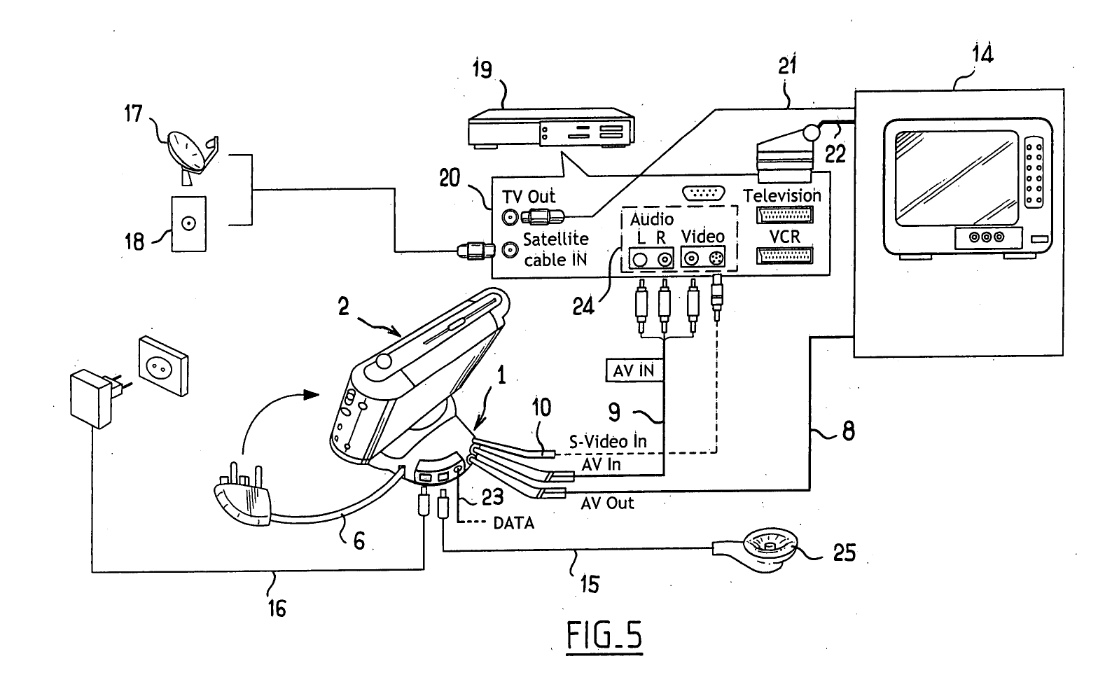

FIG. 5 is a general view of an example of use of the cradle according to the invention, and

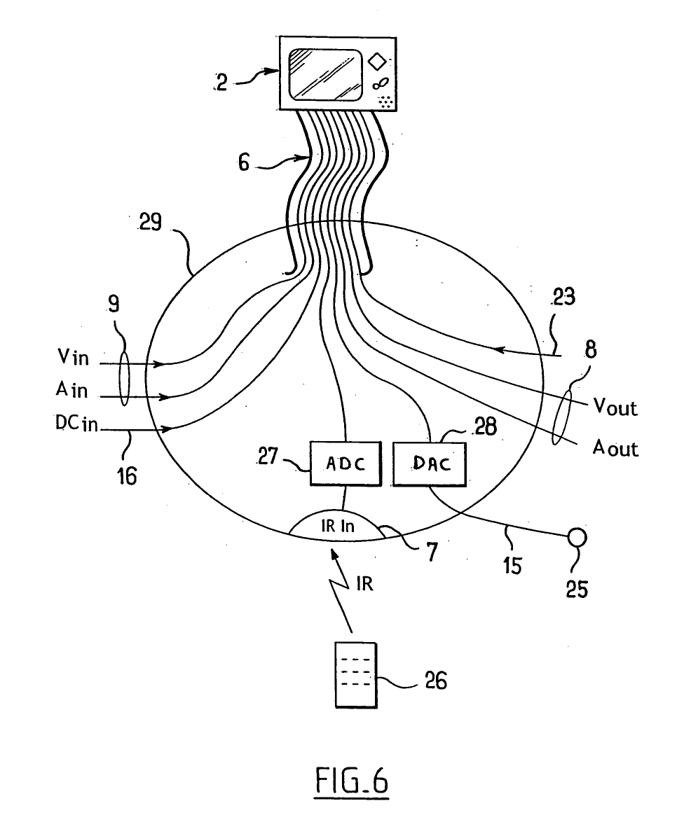

FIG. 6 is a simplified diagrammatic view of the interior of the cradle.

FIG. 1 shows the cradle 1 comprising a receptacle 3 swivelling relative to a fixed base 4 arranged below the receptacle. A housing 12 is provided on the upper part of the receptacle 3. This housing 12 is designed in such a fashion as to partially receive and maintain in upright position an audio/video portable multimedia player 2 as shown in FIGS. 2 to 4. A lower part of the player 2 is inserted into the housing 12. The receptacle also comprises an opening 11 capable of receiving a stylus 5 of said multimedia player 2.

The base 4 comprises first connection means 6 in the form of a connection cable comprising at its end a connector 6a intended to plug into corresponding plugs arranged on a lateral surface of the multimedia player 2. The cable 6 makes it possible to convey audio/video signals to and from the multimedia player, the power supply to the multimedia player, data signals from the multimedia player, as well as control signals to and from the multimedia player. As a variant, it is also possible to envisage first connection means (not shown) in the form of a connector arranged in the housing 12 and capable of engaging in a corresponding connector (not shown) arranged on the inserted part of the multimedia player 2.

In the case where the cradle is handheld, in transport position, the connector 6a arranged at the end of the cable 6 is housed in the openings 17, in FIG. 1, arranged in the housing 12.

The receptacle 3 can swivel from a so-called upright position as seen in FIG. 2 to an inclined position as seen in FIG. 3. In the upright position the multimedia player is held in the vertical position. Its display screen which is arranged on one surface remains vertical, at 900 to the horizontal plane on which the cradle is placed. In the inclined position, the player's display screen is inclined upwards at approximately 60° to the horizontal plane. A user can thus choose the position most suitable for displaying the screen of the multimedia player. In order to move from one position to the other, it is sufficient to swivel the receptacle through 180°.

The element 13 contains three power connectors, the infrared control and a data control as will be seen in FIG. 5.

The connection means 8 and 9 are cables capable of conveying audio/video signals. The cable 8 comprises two wires for conveying audio/video signals and one wire for conveying composite-type video signals. This cable 8 constitutes audio/video outputs (AV OUT) of the cradle. Similarly, the cable 9 comprises two wires for conveying audio signals and one wire for conveying composite-type video signals. This cable 9 constitutes the audio/video inputs (AV IN) of the cradle. The cable 10 constitutes a second video output capable of conveying video signals of the S-video type (S-video IN).

An example of use of the cradle according to the invention is illustrated in FIG. 5. The cradle 1 can be seen placed for example on the surface of a piece of furniture close to a satellite receiver 19 and a television (TV) 14. The satellite receiver 19 is provided for receiving the television signals from a parabolic antenna 17 positioned on the roof of a house for example. The element 19 can also be a cable receiver, or cable-box, for receiving in particular television channels from the cable 18.

The television signals originating from the parabolic antenna 17 are optionally processed then transmitted to the television 14. For example, the link between the satellite receiver 19 and the television 14 is obtained in a conventional fashion by means of an antenna cable 21 and a Peritel (or scart) cable 22 which, from the television 14, plug into corresponding connectors arranged on the rear surface 20 of the satellite receiver 19. A person skilled in the art will easily understand that other devices can be used instead of the satellite receiver 19 and other types of link, in particular in North America, can be used between the receiver and the television.

With the example in FIG. 5, it is desirable for example to record the television channels originating from the satellite receiver 19 in the multimedia player 2. In order to do this, the audio/video input cable 9 is connected to audio/video outputs 24 arranged on the rear surface 20 of the satellite receiver 19. More precisely, the cable 9 comprises three connectors, a first video connector, coloured yellow, and two connectors coloured red and white for the right-left stereo sound. For the video, it is also possible to connect the S-video input cable 10 into a corresponding plug of the outputs 24. In this case, the video connector of the cable 9 will be disconnected. The flow of the audio/video signals thus passes from the satellite receiver 19 via the cradle 1, the cable 6 to the multimedia player 2 where it is recorded continuously and in real time. The signals recorded in the multimedia player 2 can then be displayed on the television 14 via the output cable 8 (AV OUT). This cable 8 is connected to the television 14 either directly by means of three connectors (one for the composite video and two for the stereo sound), or by means of a Peritel (or scart) adaptor (not shown) receiving the three connectors and plugging into a Peritel (or scart) socket behind the television 14.

The cable 8 is suitable for transmitting images (photo albums) from the video and audio contained in the multimedia player 2 to any video and/or sound plotter.

The power cable 16, at one end connected to the mains and at the other end connected to a dedicated input (DC IN) of the cradle 1, makes it possible to supply both the cradle and the multimedia player 2.

The connector 23 can be used as a data input or output (DATA). It is possible for example to envisage connecting a second player, a keyboard or other device.

Moreover, the base 4 also comprises an infrared receiver 7 (in FIG. 2) capable of receiving infrared control signals originating from a remote control 26 (FIG. 6) and intended for the multimedia player 2. The multimedia player 2 can be programmed to carry out recordings at predetermined times. In this case, it must be capable of controlling the tuner of the satellite receiver in order to select the channel to be recorded. In order to do this, a cable 15 is connected to an output of the cradle 1. It is possible to transmit infrared control signals to the satellite receiver 19. In particular this cable 15 comprises at its free end a chip 25 which is fixed in proximity to an infrared receiver of the satellite receiver 19. This chip comprises an electric-infrared signal converter.

FIG. 6 is a very simplified block diagram of an example of the interior of a cradle. It shows a board, illustrated here by the circle 29, essentially constituted by cabling for connecting the inputs 7, 9, 23 and 16, and the outputs 8 and 15, to the multimedia player 2. For the inputs and outputs 16, 9, 23 and 8, the link is direct by simple cabling. The signals are not processed within the cradle. Only part of the power supply is used for the cradle. All the inputs/outputs (apart from the infrared receiver 7) can be a priori of socket or wire type.

The remote control 26 makes it possible to control the multimedia player 2 via the cradle. In order to do this, the infrared receiver 7 (IR IN) generates an analogue signal which is converted to a digital signal series by means of an analogue-digital converter 27 before transmission to the multimedia player. In the same manner, the digital signal series from the multimedia player is converted to an analogue signal by the digital-analogue converter 28 before transmission to the chip 25 via the cable 15.

The different cablings are contained in a single cable 6 connected to the multimedia player by means of a dedicated connector 6a.

Of course, the invention is not limited to the examples which have just been described and numerous developments can be made to these examples without exceeding the scope of the invention. It is for example possible to envisage a USB-type input/output in the cradle. In this case the connector 6a would be adapted to contain a corresponding USB socket for the multimedia player.

1. Cradle for a portable multimedia player, this player being provided with analogue-digital conversion means, recording means for recording digital signals in digital storage means and audio and video distribution means; the cradle comprising at least:
an audio input and a video input for receiving analogue audio and video signals,
an audio output and a video output for transmitting analogue audio and video signals to an external device, and
connection means for transmitting signals originating from the cradle's inputs to the multimedia player for recording, and for transmitting signals originating from the multimedia player to the cradle's outputs.

2. Cradle according to claim 1, characterized in that the connection means comprise a single cable comprising a bundle of conducting wires for the transmission of signals to and from the multimedia player, the free end of the cable comprising a connector provided with several plugs to engage with corresponding plugs of the multimedia player.

3. Cradle according to claim 2, characterized in that all of the connector's plugs have a reduced overall dimension of approximately 3 cm² or less.

4. Cradle according to claim 1, characterized in that the connection means comprise wired links capable of directly transmitting the signals originating from the audio and video inputs to the multimedia player.

5. Cradle according to claim 1, characterized in that it moreover comprises a power input, capable of receiving power from the mains via a power cable, to supply the cradle and to supply the multimedia player via the connection means.

6. Cradle according to claim 1, characterized in that it moreover comprises an infrared input constituted by an infrared receiver capable of receiving infrared control signals originating from a multimedia player remote control.

7. Cradle according to claim 6, characterized in that it moreover comprises an analogue-digital converter for converting the control signals originating from the infrared receiver to digital control signals transmitted to the multimedia player via the connection means.

8. Cradle according to claim 1, characterized in that it moreover comprises a digital-analogue converter for converting control signals originating from the multimedia player via the connection means to analogue control signals transmitted to an external device.

9. Cradle according to claim 8, characterized in that it moreover comprises an electric output called an infrared output receiving the analogue control signals from the digital-analogue converter and in that it also comprises an electric cable, connected to the infrared output, for conveying the analogue control signals, this cable comprising at its end an infrared chip for electric-infrared conversion fixed close to infrared receiving means of the external device.

10. Cradle according to claim 8, characterized in that the control signals are capable of controlling a tuner of the external device.

11. Cradle according to claim 8, characterized in that it moreover comprises a receptacle for receiving the multimedia player.

12. Cradle according to claim 1, characterized in that the receptacle is designed in swivelling fashion relative to the rest of the cradle.

13. Cradle according to claim 12, characterized in that when the cradle is placed on a horizontal plane, the swivelling axis of the receptacle is slightly inclined relative to the vertical, in such a manner that the receptacle has a first position where the multimedia player is placed vertical, and a second position after swivelling through 180° where the multimedia player is inclined relative to the vertical.

14. Cradle according to claim 1, characterized in that it has dimensions such that it can be handheld.
